(19) United States
(12) Patent Application Publication
(10) Pub. No.: US 2020/0380438 A1
(43) Pub. Date: Dec. 3, 2020

(54) SYSTEMS AND METHODS FOR USE IN GROWING PLANTS

(71) Applicant: GardenByte, Inc., Cambridge, MA (US)

(72) Inventor: Randall M. Briggs, Cambridge, MA (US)

(21) Appl. No.: 16/636,783

(22) PCT Filed: Aug. 16, 2018
(86) PCT No.: PCT/US2018/046795

§ 371 Date: Feb. 5, 2020

Related U.S. Application Data
(60) Provisional application No. 62/546,192, filed on Aug. 16, 2017.

(51) Int. Cl. G06Q 10/06; G06Q 50/02; A01G 9/08; A01G 9/029

(52) U.S. Cl. CPC G06Q 10/06313; A01G 9/0295; A01G 9/085; G06Q 50/02

(57) ABSTRACT

A system for planning the placement of plants in a multi-cell planter module. The system comprises an electronic processor having one or more electrical inputs and one or more electrical outputs, and an electronic memory device electrically coupled to the processor and having instructions stored therein. The processor is configured to access the memory and execute the instructions stored therein such that the processor is configured to: receive electrical signal(s) representative of information relating to plants to be planted in the planter module, acquire information relating to the planter module cells; determine an exclusion zone for each plant to be planted based on the received plant information and/or the acquired information relating to the planter module cells; and create a planting arrangement for the plants based on the determined exclusion zones, wherein each plant is assigned one or more cells in which it is to be placed.

### CROSS REFERENCE TO RELATED APPLICATIONS

This application claims the benefit of U.S. Provisional Application Ser. No. 62/546,192 filed on Aug. 16, 2017, which is hereby incorporated by reference in its entirety.

### TECHNICAL FIELD

This disclosure relates generally to systems and methods for growing plants, and more particularly, to automated systems and methods for use in planning and promoting the growth of plants.

### BACKGROUND

To optimize or maximize the planning of the placement of plants and/or the promotion or stimulation of the growth of plants already planted, various factors or considerations have to be taken into account. These factors or considerations may include, for example and without limitation, one or more of: plant spacing; environmental conditions to which the plants are exposed (e.g., temperature, humidity, precipitation, etc.); lighting conditions to which the plants are exposed; and how much and/or the frequency at which the plants must be tended to (e.g., watered, fed, pruned, observed, harvested, etc.).

Oftentimes, steps have to be taken to address one or more of the factors or considerations identified above. Unfortunately, many of these steps, or at least portions thereof, have to be performed manually by a human being. The logistics involved in performing these steps, and the time-consuming and painstaking nature of the tasks required to perform the steps, often make it difficult, if not unreasonable or impossible, for the steps to be adequately or satisfactorily carried out for all of the plants in a grow operation without having to, for example, expend significant capital to hire additional personnel to perform the 7 required tasks.

Accordingly, there is a need for methods and systems for use in growing plants that eliminate or at least mitigate one or more of the drawbacks discussed above.

### SUMMARY

According to one embodiment, there is provided an automated system for planning the placement of plants in a planter module having a plurality of cells in which plants may be placed. The system comprises an electronic processor having one or more electrical inputs and one or more electrical outputs, and an electronic memory device electrically coupled to the electronic processor and having instructions stored therein. The electronic processor is configured to access the memory device and execute the instructions stored therein such that the electronic processor is configured to: receive one or more electrical signals representative of information relating to plants to be planted in the planter module; acquire information relating to the plurality of cells of the planter module; determine an exclusion zone for each plant to be planted in the planter module based on at least one of the received information relating to the plants and the acquired information relating to the planter module cells; and create a planting arrangement for the plants to be planted in the planter module based on the determined exclusion zones, wherein each plant is assigned one or more cells of the planter module in which it is to be placed.

According to another embodiment, there is provided a method of planning the placement of plants in a planter module having a plurality of cells in which plants may be placed. The method comprises receiving one or more electrical signals representative of information relating to plants to be planted in the planter module, and acquiring information relating to the plurality of cells of the planter module. The method further comprises determining an exclusion zone for each plant to be planted in the planter module based on at least one of the received information relating to the plants and the acquired information relating to the planter module cells, and automatically creating a planting arrangement for the plants to be planted in the planter module based on the determined exclusion zones, wherein each plant is assigned one or more cells of the planter module in which it is to be placed.

According to yet another embodiment, there is provided a non-transitory, computer-readable storage medium storing program instructions that when executed by one or more electronic processors cause the one or more processors to perform the method of: receiving one or more electrical signals representative of information relating to plants to be planted in the planter module; acquiring information relating to the plurality of cells of the planter module; determining an exclusion zone for each plant to be planted in the planter module based on at least one of the received information relating to the plants and the acquired information relating to the planter module cells; and automatically creating a planting arrangement for the plants to be planted in the planter module based on the determined exclusion zones, wherein each plant is assigned one or more cells of the planter module in which it is to be placed.

### DESCRIPTION OF THE DRAWINGS

Preferred illustrative embodiments will hereinafter be described in conjunction with the appended drawings, wherein like designations denote like elements, and wherein:

FIG. 1 is a schematic and diagrammatic view of an illustrative embodiment of system that may be used, for example, in planning the placement of plants in a planter module;

FIG. 2 is a diagrammatic plan view of a planter module having a plurality of cells in which plants may be placed using the system illustrated in FIG. 1;

FIG. 3 is a flow diagram depicting various steps of an illustrative embodiment of a method for planning the placement of plants in a planter module having a plurality of cells in which plants may be placed;

FIGS. 4-8 are diagrammatic plan views of different planting arrangements that may be created using the method illustrated in FIG. 3, and the system illustrated in FIG. 1, and depicting different exclusion zones for different plants;

FIG. 9 is a diagrammatic view of an example of a data structure that may be used in implementing certain methodologies described herein, for example, the methodology illustrated in FIG. 3;

FIG. 10 is a flow diagram depicting various steps of another illustrative embodiment of a method for planning the placement of plants in a planter module having a plurality of cells in which plants may be placed;

FIG. 11 is an isometric view of an illustrative embodiment of planter module and a lighting system for providing light to plants in the planter module;

FIG. 12 is a schematic and diagrammatic view of an illustrative embodiment of a lighting system, for example, the lighting system illustrated in FIG. 11;

FIGS. 13a and 13b are diagrammatic views of an illustrative embodiment of an imaging system that may be used to obtain images of one or more plants;

FIGS. 14a and 14b are diagrammatic views of an illustrative embodiment of a robotic system that may be used in connection with the storage and retrieval of plants;

FIG. 15 is an isometric and diagrammatic view of an illustrative embodiment of an autonomously moveable planter; and

FIG. 16 is a schematic and diagrammatic view of an illustrative embodiment of an autonomously moveable planter.

### DETAILED DESCRIPTION OF EMBODIMENTS

The methods and systems described herein may generally be used to plan for the placement of plants to be planted, and/or to promote the growth of plants already planted. Each of the systems and methods described herein may be a standalone system or method, or one or more of the systems and/or methods may be integrated into a larger system and/or method along with, for example, one or more other systems or methods described herein. Accordingly, the present disclosure is not intended to be limited to any particular application of any of the systems and methods described herein.

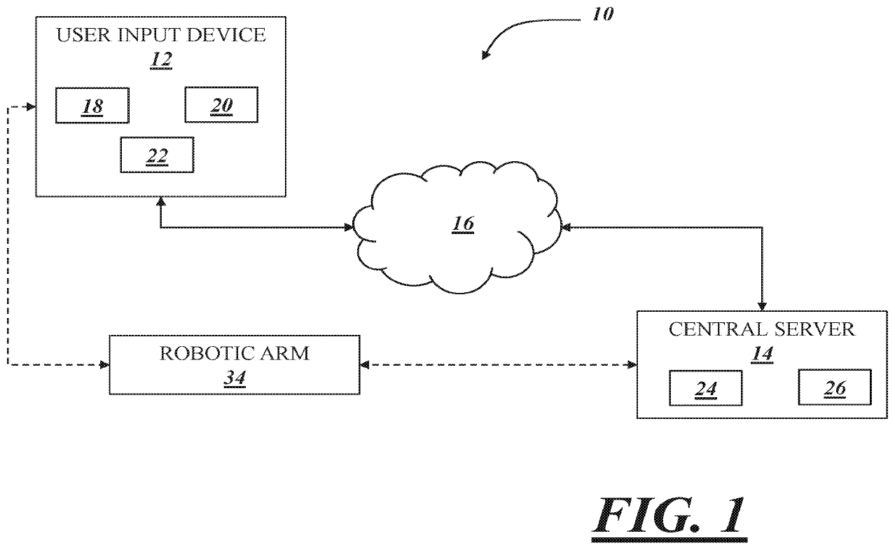

Referring to the drawings wherein like reference numerals are used to identify identical or similar components in the various views, FIG. 1 illustrates an operating environment that comprises a system 10 that may be used to implement some or all of the methodologies or features described herein. In an embodiment, the system 10 generally includes one or more user input devices 12, a central server 14, and a communication network 16 configured to facilitate communication between user input devices 12, the central server 14, and, in at least certain embodiments, other components that may or may not be part of the system 10.

The system 10 may include one or multiple user input devices 12. While the number of user input devices that may be supported by the system 10 may be unlimited, for purposes of illustration and clarity the description below will be with respect to an embodiment wherein the system 10 comprises a single user input device 12. It will be appreciated, however, that the present disclosure is not intended to be limited any particular number of user input devices 12, and that in an embodiment wherein the system 10 comprises multiple user input devices 12, the description of user input device 12 provided herein applies with equal weight to each such user input device.

The user input device 12 may be electronically connected to (e.g., hardwired or wirelessly), and configured for communication with, the central server 14; and may include any number of devices suitable to display or provide information to, and/or to receive information from, a user. As such, the user input device 12 may comprise any combination of hardware, software, and/or other components that enable a user to communicate or exchange information with the central server 14. More particularly, in an embodiment, the user input device 12 may comprise one or a combination of any number of known devices, such as, for example: a liquid crystal display (LCD); a touch screen; a plasma display; a keypad; a keyboard; a computer mouse or roller ball; a microphone; a speaker; a handheld device (e.g., telephone, smartphone, tablet, personal digital assistant (PDA), etc.); or any other display or monitor device. As such, it will be appreciated that the user input device 12 is not limited to any one specific input device or combination of devices.

In an embodiment, the user input device 12 may further include an electronic processing device or electronic processor 18 and an electronic memory device 20 that is part of or accessible by the processing device 18. The processing device 18 may include any type of suitable electronic processing device (e.g., programmable microprocessor, microcontroller, central processing unit (CPU), application specific integrated circuit (ASIC), etc.) that is configured to process data and/or execute appropriate programming instructions for software, firmware, programs, applications, algorithms, scripts, etc., necessary to perform various functions of the user input device 12 and/or some or all of functionality described herein below.

The memory device 20 may include, for example, random access memory (RAM), read only memory (ROM), hard disk(s), universal serial bus (USB) drive(s), memory card(s), erasable programmable memory (e.g., EPROM and EEPROM), flash memory, or any other type of suitable electronic memory means, and may store a variety of data. This data may include, for example, one or more of software (e.g., code or logic), firmware, programs, applications, information, algorithms, scripts, data structures, etc., required to perform functions of the user input device 12 and/or system 10. Alternatively, rather than all of the aforementioned information/data being stored in a single memory device, in an embodiment, multiple suitable memory devices may be provided.

In any event, the aforementioned instructions/data may be provided as a computer program product, or software, that may include a non-transitory, computer-readable storage medium. This storage medium may have instructions stored thereon, which may be used to program a computer system (or other electronic device, for example, the processing device 18) to implement or control some or all of the functionality described herein, including one or more steps of the methods described herein. A computer-readable storage medium may include any mechanism for storing information in a form (e.g., software, processing application) readable by a machine (e.g., a computer, processing unit, etc.). The computer-readable storage medium may include but is not limited to: magnetic storage medium (e.g., hard disk drive); optical storage medium (CD-ROM); magneto optical storage medium; read only memory (ROM); random access memory (RAM); erasable programmable memory (e.g., EPROM and EEPROM); flash memory; solid state drive (SSD); universal serial bus (USB) thumb drive; or other types of medium suitable for storing program instructions and other information.

In addition to the above, the user input device 12 may include one or more user interfaces 22, such as a graphical user interface (GUI) and/or text-based user interface, or may be configured to generate and display such one or more interfaces that may be used in conjunction with one or more of the user input devices identified above (e.g., a text based user interface may be displayed on an LCD screen of a user input device and a keyboard thereof may be used in conjunction with the user interface, a GUI may be displayed on an LCD screen of a user input device and a mouse thereof may be used in conjunction with the user interface, etc.). In either instance, one or more components of the system 10 (e.g., central server 14, a computer or software application (referred to below as an “app” stored on the user input device 12 or elsewhere in the system 10, etc.) may be configured to generate user interfaces 22 in the form of a graphical and/or text-based interface having one or more user-selectable or user-inputtable fields, icons, links, radio buttons, etc. that may be displayed on a suitable device and allow a user to interact or communicate with the central server 14 via text, voice, or graphical interfaces, to name a few. It will be appreciated that in an embodiment wherein the user interface 22 is communicated to the user input device 12 from, for example, the central server 14, it may be done so across the communication network 16 using any number of well-known communication techniques and protocols, such as, for example, one or more of those described below.

Regardless of the particular form the user input device 12 takes, it is configured to provide an interactive interface that allows a user to interact with the central server 14 for the purposes described below. For instance, the user input device 12 may be configured to display a message prompting a user to input certain information (e.g., type(s) and/or numbers of plants, stage of plant growth, planter module type, etc.), and to also provide a means by which the information can be inputted (e.g., user-selectable or user-inputtable fields, icons, etc.). The input provided by the user can be communicated to the central server 14, which may take certain action in response to the received input. To that end, the user input device 12 may include or be electrically connected or coupled to certain communication-supporting infrastructure (e.g., one or more known components/devices, such as, for example, modems, routers, antennas, electromechanical ports, transceivers, etc.) to allow for the communication and exchange of data between the user input device 12 and one or more other components of the system 10, for example, the central server 14. As described elsewhere herein, the communication between user input device 12 and the central server 14 may be supported or facilitated by any number of well known communication techniques and protocols, such as, for example, one or more of those described below.

The central server 14, which may be a standalone component or part of either another component of the system 10 or a larger network or system, may be used to control, govern, or otherwise manage certain operations or functions of the system 10. The central server 14 may be implemented with a combination of hardware, software, firmware, and/or middleware, and, according to an illustrative embodiment, includes a processing device or electronic processor 24 and a memory device 26. In one embodiment, the memory device 26 is a component of the processing device 24; in other embodiments, however, the memory device 26 is separate and distinct from the processing device 24 but accessible thereby.

The processing device 24 may include any type of suitable electronic processing device (e.g., programmable microprocessor, microcontroller, central processing unit (CPU), application specific integrated circuit (ASIC), etc.) that is configured to process data and/or execute appropriate programming instructions for software, firmware, programs, applications, algorithms, scripts, etc., necessary to perform various functions of the central server 14 and/or some or all of functionality described herein below. The processing device 24 may include or be electrically connected or coupled to certain communication-supporting infrastructure (e.g., one or more known components/devices, such as, for example, modems, routers, antennas, electromechanical ports, transceivers, etc.) to allow for the communication and exchange of data between the central server 14 and one or more other components of the system 10, for example, the user input device 12. As described elsewhere herein, this communication may be supported or facilitated by any number of well-known communication techniques and protocols, such as, for example, one or more of those described below.

The memory device 26 may include, for example, random access memory (RAM), read only memory (ROM), hard disk(s), universal serial bus (USB) drive(s), memory card(s), erasable programmable memory (e.g., EPROM and EEPROM); flash memory, or any other type of suitable electronic memory means, and may store a variety of data. This data may include, for example, one or more of software (e.g., code or logic), firmware, programs, applications, information, instructions, algorithms, scripts, data structures, etc., required to perform some or all of the functions of the central server 14 and/or system 10. Alternatively, rather than all of the aforementioned information/data being stored in a single memory device, in an embodiment, multiple suitable memory devices may be provided.

In any event, the aforementioned instructions/data may be provided as a computer program product, or software, that may include a non-transitory, computer-readable storage medium. This storage medium may have instructions stored thereon, which may be used to program a computer system (or other electronic device, for example, the processing device 24) to implement or control some or all of the functionality described herein, including one or more steps of the methods described herein. A computer-readable storage medium may include any mechanism for storing information in a form (e.g., software, processing application) readable by a machine (e.g., a computer, processing unit, etc.). The computer-readable storage medium may include but is not limited to: magnetic storage medium (e.g., hard disk drive); optical storage medium (CD-ROM); magneto optical storage medium; read only memory (ROM); random access memory (RAM); erasable programmable memory (e.g., EPROM and EEPROM); flash memory; solid state drive (SSD); universal serial bus (USB) thumb drive, or other types of medium suitable for storing program instructions and other information.

The communication network 16 may comprise a wired or wireless network, such as, for example: a suitable Ethernet network; the Internet; a radio and telecommunications/telephony network, such as, for example and without limitation, cellular networks, analog voice networks, or digital fiber communications networks; a storage area network such as Fibre Channel SANs; or any other suitable type of network and/or protocol (e.g., local area networks (LANs); wireless local area networks (WLANs); broadband wireless access (BWA) networks; personal Area Networks (PANs) such as, for example, Bluetooth; etc.). The network or communication interfaces of the various components may use standard communications technologies and protocols, and may utilize links using technologies such as, for example, Ethernet, IEEE 802.11, integrated services digital network (ISDN), digital subscriber line (DSL), and asynchronous transfer mode (ATM), ZigBee, near field communications (NFC), as well as other known communications technologies. Similarly, the networking protocols used on a network to which the kiosks 12 and the central host 14 are interconnected may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. Further, the data exchanged over such a network by the network interfaces of the various components may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as, for example, the secure sockets layer (SSL), Secure HTTP and/or virtual private networks (VPNs), the international data encryption standard (DES or IDEA), triple DES, Blowfish, RC2, RC4, R5, RC6, as well as other known data encryption standards and protocols. In other embodiments, custom and/or dedicated data communications, representation, and encryption technologies and/or protocols may be used instead of, or in addition to, the particular ones described above.

In addition to the structural components of the system 10 described above, and the user input device 12 and the central host 14 thereof, in particular, in an illustrative embodiment the system 10 is further configured to support a variety of functions and features. As will be described in greater detail below, this additional functionality may be performed or executed by one or a combination of the components of the system 10 (i.e., one or both of the user input device 12 and the central server 14), or one or more additional components not specifically described above either alone or in conjunction with one or more of the above-described components. Several of these various functions and features will now be described.

### Placement of Plants in a Planter Module

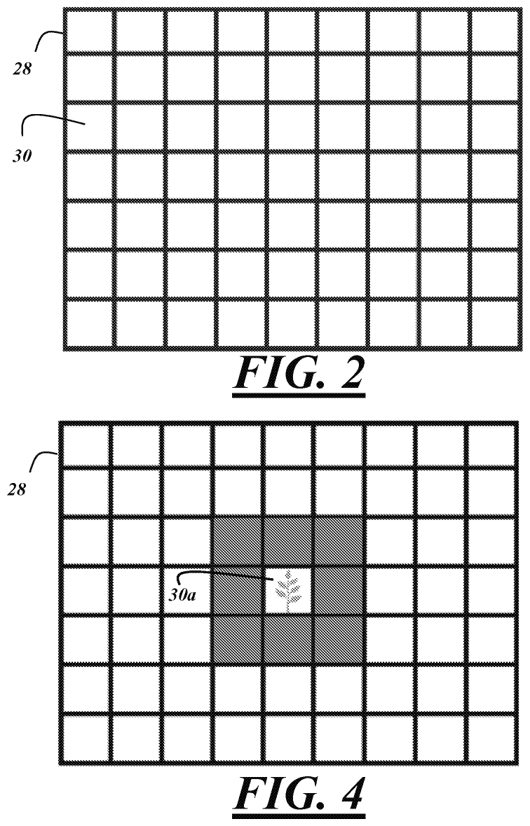

In an embodiment, the system 10 may configured for use in planning the placement of plants in a planter module having a plurality of cells in which plants may be placed. FIG. 2 depicts an example of such a planter module 28 having a plurality of cells 30 arranged in grid. In the illustrated embodiment, all of the cells 30 in the grid have the same size and shape. It will be appreciated, however, that in other embodiments, one or more cells 30 may have a different size and/or shape than one or more other of the cells 30, and different planter modules may have different numbers of cells. Accordingly, it will be appreciated that the present disclosure is not intended to be limited to a planter module having a particular number of cells or a particular cell arrangement; but rather, the system 10 may find application with planter modules having any number of cell arrangements (e.g., number of cells, cell sizes and shapes, and/or cell spacing).

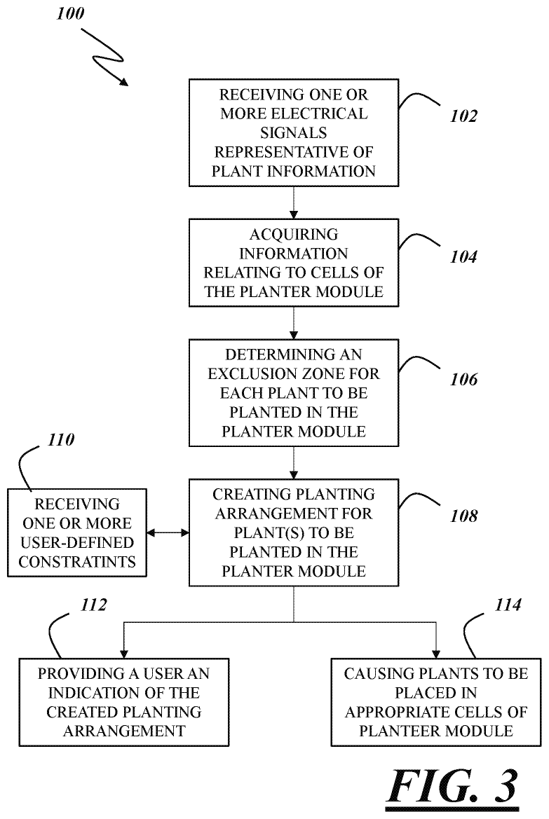

With reference to FIG. 3, there is shown a method 100 of planning the placement of plants in a multi-cell planter module. For purposes of illustration and clarity, method 100 will be described only in the context of the system 10 described above, and an implementation of system 10 wherein system comprises both the user input device 12 and the central host 14, in particular. It will be appreciated, however, that the application of the present methodology is not meant to be limited solely to such implementations or embodiments, but rather method 100 may find application with any number of types or implementations/embodiments of the system 10 (e.g., an implementation wherein system 10 comprises only the user input device 12). It will be further appreciated that while the steps of method 100 will be described as being performed or carried out by one or more particular components of the system 10, in other embodiments some or all of the steps may be performed by components of the system 10 other than that or those described. Accordingly, it will be appreciated that the present disclosure is not intended to be limited to an embodiment wherein particular components are configured to perform any particular steps. Additionally, it will be appreciated that unless otherwise noted, the performance of method 100 is not meant to be limited to any one particular order or sequence of steps; rather the steps may be performed in any suitable and appropriate order or sequence and/or at the same time.

In an embodiment, method 100 includes a first step 102 of receiving one or more electrical signals representative of information relating to plants to be planted in the planter module. This information may comprise a number of different types of information. For example, the information may comprise: the type(s) of plants to be planted and/or the number of each type of plant the size(s) of one or more of the plants (e.g., height, width, diameter, etc.); the shape of one or more of the plants; an exclusion zone (described in greater detail below) for one or more of the plants; and/or the stage of growth of one or more of the plants (e.g., seedling, juvenile, adult, etc.), to cite a few possibilities. Additionally, because plants may grow differently when exposed to different types and/or amounts of light, the information may also include, for example, information relating to the lights to be used to stimulate/promote the growth of the plants. This may include the type of light (e.g., infrared), the intensity of the light, and/or other relevant information.

Regardless of the type of information that is represented by the received signals, in an embodiment, the electrical signals are received in step 102 by the processing device 24 of the central host 14 from the user input device 12. The electrical signals may be generated by the user input device 12 in one or more ways. One way, though certainly not the only way, is in response to one or more user inputs made through a user interface of the user input device 12. More particularly, the user input device 12 may comprise or be configured to display (e.g., through an app) one or more user-inputtable or user-selectable fields with which the user may interact to facilitate the providing of certain information. For example, a user may interact with a graphical user interface (GUI) generated by the processing device 18 of the user input device 12 to select particular types of plants. In response, the user may be prompted to indicate the number of each type of plant, as well as, in certain embodiments, other information relating to the plant(s), such as for example, one or more pieces of information identified above. As the information is input, or once all of the information has been inputted, one or more electrical signals representative of the input information may then be communicated from the processing device 18 of the user input device 12 to the central server 14 over the communication network 16 and used for purposes described below.

In an embodiment, the method 100 further comprises a step 104 of acquiring information relating to the cells of the planter module. This information may comprise a number of different types of information. For example, the information may include the number of cells, the size of one or more of the cells, the shape of one or more of the cells, the spacing between two or more cells, and/or the location of each cell in a grid formed by the cells. While certain types of information have been specifically identified above, it will be appreciated that relevant information other than that identified above may additionally or alternatively be acquired.

The information acquired in step 104 may be acquired in one or more ways. One way is in response to one or more user inputs made through a user interface of the user input device 12. More particularly, the user input device 12 may comprise or be configured to display (e.g., through an app) one or more user-inputtable or user-selectable fields with which the user may interact to facilitate the providing of the information. For example, a user may interact with a graphical user interface (GUI) generated by the processing device 18 of the user input device 12 to select a particular grid arrangement. In response, the user may be prompted to indicate information relating to one or more of the cells of the grid, such as for example, one or more pieces of information identified above. As the information is input, or once all of the information has been inputted, one or more electrical signals representative of the input information may then be communicated from the processing device 18 of the user input device 12 to the central server 14 over the communication network 16 and used for purposes described below. Another way the information may be acquired in step 104 is obtaining it from a memory device, for example, the memory device 26 of the central host. In an embodiment wherein only one grid arrangement is supported, the information may be obtained automatically by, for example, the central server processing device 24. In an embodiment where multiple grid arrangements are supported, however, the information may be obtained in response to a user input received from the user input device 12 representative of a selected grid arrangement. In any event, it will be appreciated that the information may be acquired in step 104 in any number of ways, and that the present disclosure is not intended to be limited to any particular way(s) of doing so.

In a step 106 of the method 100, an exclusion zone for each plant to be planted in the planter module is determined. In an embodiment, the exclusion zone for each plant is determined based on the plant-related information received in step 102 and/or the planter module/cell-related information received in step 104. An exclusion zone is an area surrounding a plant that represents the amount of space a plant occupies or is expected to occupy at a given growth stage, and within which, for example, other plants should not be planted so that the plant has sufficient room to grow. The exclusion zone for a given plant may be defined in terms of whole or partial cells of the planter module and may have any number of sizes and/or shapes, depending on the particular plant and attributes thereof (e.g., size and shape) and attributes of the cells themselves (e.g., size, location, shape, etc.). Additionally, in some embodiments, each type of plant will have a single exclusion zone associated therewith, while in other embodiments, a given plant type may have multiple exclusion zones from which a selection is made based on various factors (e.g., stage of growth, lights used to stimulate growth, size of cells, etc.). Further, depending on the implementation, an exclusion zone may be a two-dimensional exclusion zone or may comprise a three-dimensional exclusion zone that extends both horizontally and vertically (e.g., in implementations where the planter module is a multi-tiered module).

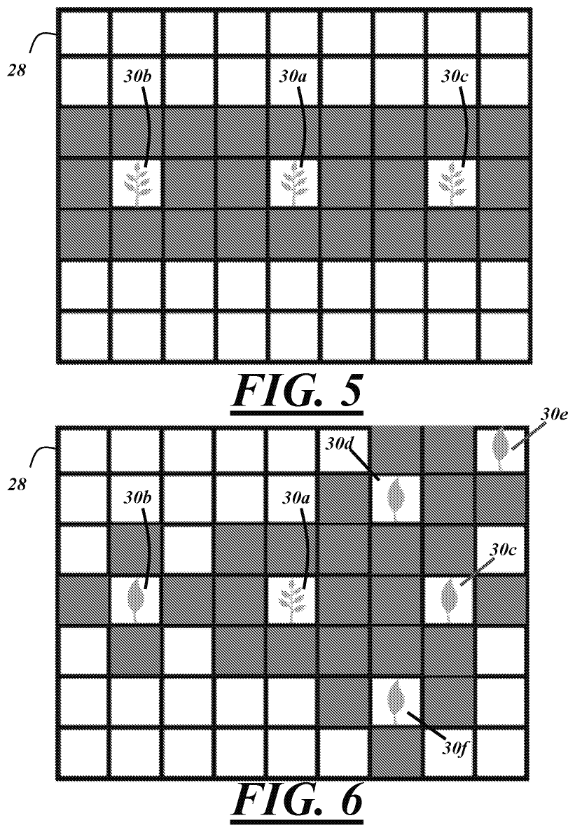

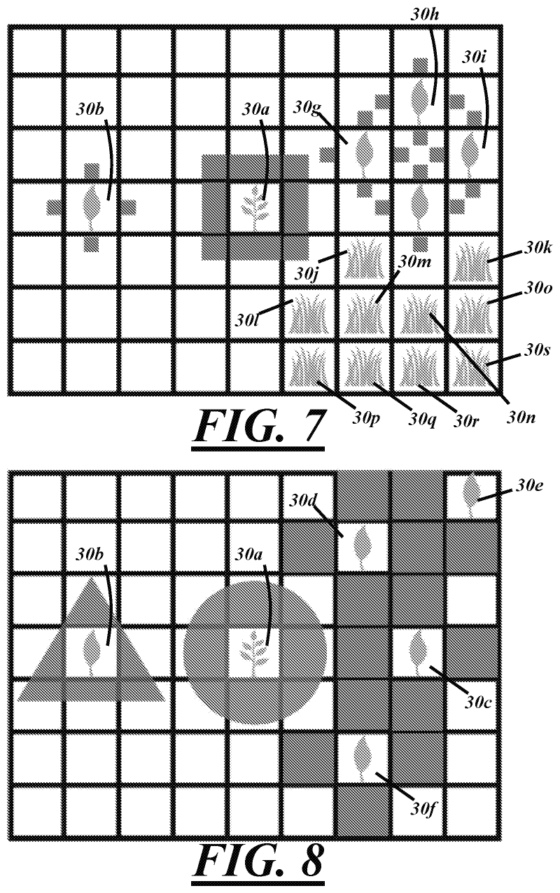

The concept of exclusion zones will be better understood and appreciated when considered in view of FIGS. 4-8 that depict illustrative examples of exclusion zones for one or more plants. More specifically, FIG. 4 illustrates a planter module having a plurality of equally sized and shaped cells 30. For the plant placed in the cell 30a, the exclusion zone was determined to be a square-shaped exclusion zone extending a single cell in each direction. FIG. 5 depicts the same planter illustrated in FIG. 4, except that plants are placed in three cells—cells 30a, 30b, and 30c. As with the plant illustrated in FIG. 4, each plant shown in FIG. 5 has a square-shaped exclusion zone extending a single cell in each direction. In FIG. 6, plants are placed in six (6) cells—30a-30f. Like FIGS. 4 and 5, the plant placed in cell 30a has square-shaped exclusion zone extending a single cell in each direction. Each of the plants in cells 30b-30f, however, has a diamond shaped exclusion zone extending a single cell to the front, to the back, and to each side of the cell in which the plant is placed. FIG. 7 depicts a first type of plant placed in cell 30a, a second type of plant placed in each of cells 30b, 30c, 30g, 30h, and 30i, and a third type of plant placed in each of cells 30j-30s. The plant in cell 30a has a square shaped exclusion zone extending only a portion of a cell in each direction. Each of the plants in cells 30b, 30c, and 30g-30i have a diamond shaped exclusion zone extending only a portion of a cell to the front, to the back, and to each side of the cell in which the plant is placed. And, none of the plants in cells 30j-30s have an exclusion zone. Finally, in FIG. 8, a first type of plant is placed in cell 30a, and a second type of plant is placed in each of cells 30b-30f. The plant in cell 30a has a circular exclusion zone extending only a portion of a cell in each direction. The plant in cell 30b has a triangular exclusion zone extending a portion of a cell in each direction. And the plants in cells 30c-30f have diamond shaped exclusion zones extending a single cell to the front, to the back, and to each side of the cell in which the plant is placed. Accordingly, it be appreciated in view of the above that the present disclosure is not intended to be limited to any particular shape or size of exclusion zones.

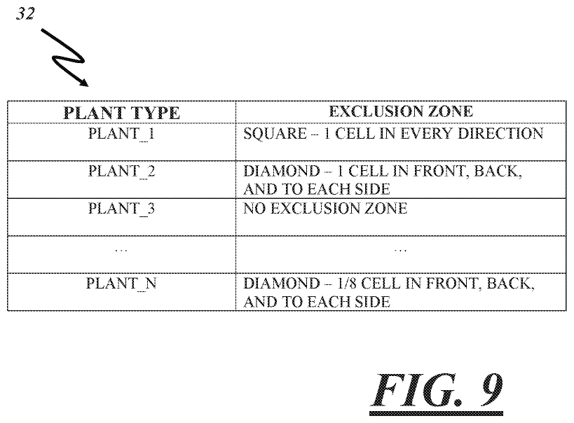

In any event, the exclusion zone for a given plant may be determined in step 106 in a number of ways. One way is that the exclusion zone may be input or provided by a user and received as part of the information received in step 102. In such an embodiment, step 106 may comprise processing the received information to obtain or determine the exclusion zone. Another way is by using a data structure that correlates plant information (e.g., the information received in step 102) with predetermined, empirically-derived exclusion zones stored in the data structure. More particularly, in an embodiment, and with reference to FIG. 9 which illustrates an example of a data structure 32, the type of plant may be looked up in the data structure 32 and the exclusion zone associated therewith can be determined. In other embodiments, information in addition to the plant type may also be looked-up in an appropriately configured data structure to determine the appropriate exclusion zone. In embodiments such as those described above, the exclusion zones may be predetermined/empirically derived for each type of plant and/or information relating thereto, and the exclusion zones may be loaded into the data structure 32 stored in or on, for example, the memory 26 of the central server 14. The data structure 32 may then be accessed by, for example, the processing device 24 of the central host 14 to determine the exclusion zone for a particular plant and/or particular information relating thereto.

In other embodiments, information relating to the planter module and the cells thereof, in particular, may also be taken into account in determining the exclusion zone. For example, in an embodiment, the plant-related information (received in step 102) and planter module/cell-related information (received in step 104) may be used together in conjunction with an appropriately configured data structure to determine an exclusion zone for a particular plant in a particular planter module and/or cell arrangement thereof. Alternatively, information acquired in step 104 may be used the select an appropriate data structure to be used in determining exclusion zones for plants to be placed in that particular planter module. The plant type (and/or other plant-related information) is then looked up in the selected data structure to determine an exclusion zone for that particular plant. In any event, it will be appreciated that in at least some embodiments, especially embodiments where multiple planter modules and/or grid arrangements are supported, information relating to the planter module may also be taken into account in determining exclusion zones in step 106.

While particular ways of determining an exclusion zone for a plant have been described in detail above, it will be appreciated that in other embodiments, different techniques may be used. For example, one or ordinary skill in the art will appreciate that with appropriate plant information (e.g., plant size) and appropriate planter module information (e.g., size, spacing, etc.), an exclusion zone for a particular plant may be calculated using one or more equations or algorithms. Accordingly, the present disclosure is not intended to be limited to any particular way(s) of determining exclusion zones, but rather any suitable technique may be used.

Following the determination in step 106 of exclusion zones for each plant to be planted in the planter module, the method 100 proceeds to a step 108 of automatically creating a planting arrangement for the plant(s) to be planted in the planter module based, at least in part, on the exclusion zone(s) determined in step 106. More specifically, step 108 comprises assigning each plant one or more cells in which that plant is to be placed. In an embodiment, the creating step 108 comprises creating a layout or arrangement in which the exclusion zones of the plants in the arrangement do not overlap. In other embodiments, however, some overlap in exclusion zones may be permissible for at least certain plants, in which case the creating step may comprise creating the layout/arrangement wherein there is a permissible or allowable amount of overlap between exclusion zones of some or all of the plants. In any event, in an embodiment, the processing device 24 of the central server 14 is configured to take the exclusion zone information determined in step 106 and information relating to the planter module (e.g., the cell arrangement and cell attributes (e.g., size, spacing, location, shape, etc.)), and create the planting layout/arrangement for the plants to be planted in the planter module. In at least some embodiments, the creating step 108 may also comprise creating a layout or arrangement in such a way that the plants and their exclusion zones can be accommodated such that a structural object (e.g., a component of the planter module, a wall, etc.) does not interfere with either a plant or its exclusion zone. In other words, the plants are placed at locations where the plant will not grow into or against a structural object, but rather will grow without interference.

In an embodiment, information in addition to that received in step 102 and/or acquired in step 104 may also be taken into account in creating the planting arrangement in step 108. More specifically, one or more electrical signals representative of one or more user-defined constraints relating to plant placement may be received in an optional step 110, and the information represented by the received signal(s) may be used in step 108 to create the planting layout/arrangement. The user-defined constraints may comprise, for example, instructions that some or all of the plants are to be grouped closely together and/or in a particular area or region of the planter module, that the spacing between two or more plants or types of plants is to be maximized, and the like. This information may be received from the user input device 12 in the same manner described above with respect to step 102, and as such, the description above will not be repeated but rather is incorporated here by reference.

In an event, the processing device 24 of the central host may be configured to execute appropriate logic and/or other instructions in order to create a suitable arrangement. For example, the processing device 24 may place each plant one-at-a-time based on the exclusion zone of that plant and others already placed/assigned to a cell, may randomly place all of the plants and then adjust the placement of some or all of the plants to account for the exclusion zones, or may perform step 108 using any other suitable technique known in the art. In any event, step 108 may be carried out or performed in a number of ways, and therefore, the present disclosure is not intended to be limited to any particular way(s) of doing so.

Once a layout/arrangement has been created in step 108, method 100 may comprise a step 112 of providing a user an indication of the layout/arrangement (e.g., cell assignments for each plant) that may be used by the user in actually placing the plants in the planter module. This indication may take a number of forms and may be provided in a number of ways.

In an embodiment, the processing device 24 of the central host 14 is configured to generate an indication and to communicate it to the user input device 12 where it may be displayed on a user interface thereof (e.g., display screen). For example, the processing device 24 may be configured to generate a GUI that contains or comprises the created layout, and that has the same or similar appearance as the depictions in FIGS. 4-8. In such an embodiment, one or more electrical signals representative of the GUI may be communicated to the user input device 12 from the central host 14 over the communication network 16, where the signal(s) is/are processed and the GUI displayed for a user to see.

In another embodiment, and if the system is so configured, step 112 may comprise causing the cell(s) within which a plant is to be placed to be illuminated from one or more light sources located above the planter module 28, in the cells 30 themselves, or otherwise. In such an embodiment, the user input device 12 may be configured to control the light source(s) directly or may be configured to issue commands to a light source controller which would then control the light source(s) to illuminate the appropriate cell(s).

In yet another embodiment, step 112 may comprise utilizing augmented reality to visualize the arrangement created in step 108. More specifically, the user input device 12, or a component thereof, or a virtual reality headset that may be used in conjunction with or separate from the user input device 12, may be used to obtain an image of the planter module 28, and then the user input device 12 and/or the central server 14 may be configured to cause the arrangement created in step 112 to be overlaid onto the image so that the user can see the created arrangement.

It will be appreciated in view of the foregoing that any number of indications may be provided in any number of ways in step 112, and therefore, the present disclosure is not intended to be limited to any particular indication(s) or way(s) of providing the indication.

While in an embodiment the method 100 may include step 112 of causing an indication of the arrangement/cell assignments created in step 108 to be provided to a user, in other embodiments, method 100 may not include such a step or may further include one or more other steps following step 108 such as that or those described below. More particularly, in some embodiments, method 100 may comprise a step 114 of causing the plants to be automatically placed in the appropriate cells of the planter module in accordance with the arrangement created in step 108. One way in which this may be done is by using techniques known in the art to cause and/or control a robotic arm 34 of the system 10 (shown diagrammatically in FIG. 2) having an appropriate end effector to retrieve a plant and place it in the appropriate cell. In an embodiment, the user input device 12 may be configured to control the operation of the robotic arm, while in other embodiments, a dedicated controller may be configured to control the operation of the robotic arm in response to receiving commands from the user input device 12 or the central server 14 to which the controller is electrically connected or coupled, or in response to receiving the layout created in step 108 from the user input device 12 or the central server 14.

While the description of method 100 has thus far been with respect to creating a planting arrangement for plants not already placed in cells of the planting module, it will be appreciated that at least certain aspects of method 100 may be used to rearrange plants already planted in the planter module.

For example, rather than receiving in step 102 information relating to plants to be planted in the planter module, step 102 may comprise receiving one or more electrical signals representative information relating to plants already planted in the planter module. In an embodiment, the electrical signals may be representative of information extracted or determined from one or more images of the plant obtained by one or more cameras or may be representative of one or more images of the plant that may then be processed by, for example, the processing device 24 of the central server 14 to determine certain desired information about the plant. Alternatively, the received signals may be representative of information input by a user in the manner described elsewhere above.

Once the information relating to the plant(s) in the planter module is received, it may be used in the same manner described above with respect to step 106 to determine “new” exclusion zones for each plant (which may be necessary if one or more plants have grown) and then, in step 108, a new arrangement/layout may be created. Following step 108, step 112 or step 114 may be performed in the same or similar way as that described above in order to rearrange the planting arrangement in the planter module.

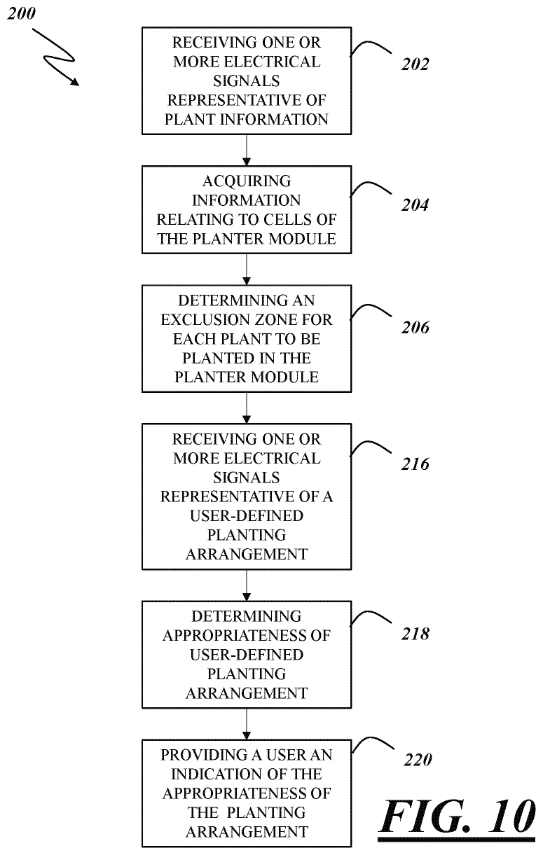

With reference to FIG. 10, another embodiment of a method for planning the placement of plants in a planter module (i.e., method 200) is illustrated. In this embodiment, method 200 includes step 202-206, which are the same as steps 102-106 of method 100. As such, a description of steps 202-206 will not be provided but rather the description of steps 102-106 set forth elsewhere above is incorporated here by reference. Unlike method 100, however, method 200 does not include step 108 of creating a planting arrangement. Instead, method 200 includes a step 216 of receiving one or more electrical signals representative of a user-defined planting arrangement, and a step 218 of evaluating the user-defined planting arrangement to determine whether the layout is appropriate in view of various constraints (e.g., constraints relating to overlap between exclusion zones).

In such an embodiment, the signal(s) received in step 216 may be generated and/or received in the same or similar manner as those received in, for example, step 102. And step 218 may be performed in a similar way that step 108 of method 100 is performed by executing logic and instructions to determine if the proposed layout/arrangement is appropriate (e.g., determining if exclusion zones overlap, and/or if the overlap is greater than a particular allowable or permissible threshold).

In any event, following step 218, the method 200 may comprise a step 220 of providing the user an indication as to whether or not the proposed layout/arrangement is appropriate. One way this indication may be provided, though certainly not the only way, is that the processing device 24 of the central host 14 is configured to generate an indication and to communicate it to the user input device 12 where it may be displayed on a user interface thereof (e.g., display screen). For example, the processing device 24 may be configured to generate a GUI that contains or comprises a message relating to the appropriateness of the proposed layout. In such an embodiment, one or more electrical signals representative of the GUI may be communicated to the user input device 12 from the central host 14 over the communication network 16, where the signal(s) is/are processed and the GUI displayed for a user to see. It will be appreciated, however, that other suitable indications are certainly possible, and thus, the present disclosure is not intended to be limited to any particular indication(s) or way(s) of providing an indication.

### Automatic Lighting Control

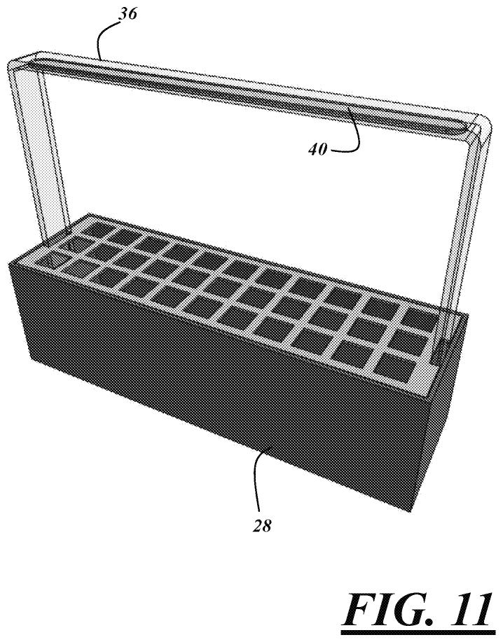

Another feature of the present disclosure relates to automatic control of a lighting system used, for example, to stimulate/promote growth of one or more plants in a planter module. The lighting system 36 may be used for plants growing indoors or outdoors, and for plants growing in soil or without soil (e.g., hydroponics or aeroponics). For example, FIG. 11 depicts an illustrative embodiment wherein the lighting system 36 is associated with the planter module 28 and is configured to provide light to plants in the planter module 28.

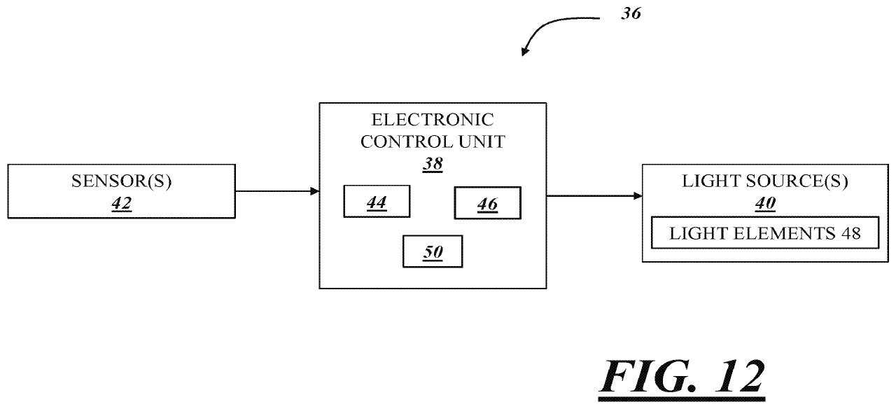

In accordance with this feature, and as illustrated in FIG. 12, in an embodiment, the lighting system 36 comprises an electronic control unit (ECU) 38, one or more light sources 40 configured to provide light to plants planted in the planter module 28, and one or more sensors 42 each configured to be used to detect or sense one or more conditions. In some embodiments, the lighting system 36 is part of the system 10 described above such that the system 10 comprises the lighting system 36 and one or both of the user input device 12 and the central host 14. In such an embodiment, the ECU 38 of the lighting system may comprise the user input device 12 (e.g., the processing device 18 and memory device 20) or the central server 14 (e.g., the processing device 24 and memory device 26). In other embodiments, however, the lighting system 36 is a standalone system that is not part of a larger system.

The ECU 38 may comprise a processing device 44 and a memory device 46 that is part of or electrically connected/coupled to and accessible by the processing device 44. As with the processing devices described above, the processing device 44 may include any type of suitable electronic processing device (e.g., programmable microprocessor, microcontroller, central processing unit (CPU), application specific integrated circuit (ASIC), etc.) that is configured to process data and/or execute appropriate programming instructions for software, firmware, programs, applications, algorithms, scripts, etc., necessary to perform various functions of the ECU 38 and lighting system 36, including some or all of functionality described herein below. In an illustrative embodiment, the processing device 44 may include or be electrically connected or coupled to certain communication-supporting infrastructure (e.g., one or more known components/devices, such as, for example, modems, routers, antennas, electromechanical ports, transceivers, etc.) to allow for the communication and exchange of data between the ECU 44 and one or more other components, for example, the user input device 12 and/or the central server 14 in an embodiment wherein the lighting system 36 is part of the system 10. This communication may be supported or facilitated by any number of well-known communication techniques and protocols, such as, for example, one or more of those described elsewhere herein

As with the other memory devices described above, the memory device 46 may include, for example, random access memory (RAM), read only memory (ROM), hard disk(s), universal serial bus (USB) drive(s), memory card(s), erasable programmable memory (e.g., EPROM and EEPROM); flash memory, or any other type of suitable electronic memory means, and may store a variety of data. This data may include, for example, one or more of software (e.g., code or logic), firmware, programs, applications, information, instructions, algorithms, scripts, data structures, etc., required to perform some or all of the functions of the ECU 38. Alternatively, rather than all of the aforementioned information/data being stored in a single memory device, in an embodiment, multiple suitable memory devices may be provided.

In an embodiment, the aforementioned instructions/data may be provided as a computer program product, or software, that may include a non-transitory, computer-readable storage medium. This storage medium may have instructions stored thereon, which may be used to program a computer system (or other electronic device, for example, the processing device 44) to implement or control some or all of the functionality described herein, including one or more steps of the methods described herein. A computer-readable storage medium may include any mechanism for storing information in a form (e.g., software, processing application) readable by a machine (e.g., a computer, processing unit, etc.). The computer-readable storage medium may include but is not limited to: magnetic storage medium (e.g., hard disk drive); optical storage medium (CD-ROM), magneto optical storage medium; read only memory (ROM), random access memory (RAM); erasable programmable memory (e.g., EPROM and EEPROM); flash memory; solid state drive (SSD); universal serial bus (USB) thumb drive; or other types of medium suitable for storing program instructions and other information.

The lighting source(s) 40 is/are electrically connected or coupled to and configured to be controlled by the ECU 38. This electrical connection may be a wired connection whereby the light source(s) 40 are electrically connected or coupled to the ECU 38 by one or more wires. Alternatively, the electrical connection may be a wireless connection whereby the light source(s) 40 are wirelessly connected to the ECU 38 using known techniques such as, for example, one or more of those described elsewhere herein.

The lighting source(s) 40 may be mounted to or carried by the planter module 28; or alternatively may comprise a standalone structure that can, in at least some instances, be moved, for example, from one planter module to another or from one area of plants to another (e.g., in an instance wherein the plants are in field or garden as opposed to a planter module). Each lighting source 40 is comprised one or more individual light elements 48. In an embodiment where the lighting system 36 comprises multiple light sources 40, the light sources may be controlled in unison or may be controlled individually or in groups comprising less than all of the light sources 40. Similarly, in an embodiment wherein one of the light sources 40 comprises multiple light elements 48, the light elements of that light source may be controlled in unison, individually, or in groups. For purposes of clarity and illustration, the description below will be with respect to an embodiment where the lighting system 36 has a single light source comprised of multiple light elements. It will be appreciated, however, that the present disclosure is not intended to be limited any particular number of light sources, and that in an embodiment wherein the lighting system comprises multiple light sources, the description of the light source 40 provided herein applies with equal weight to each such light source 40.

The light elements 48 of the light source 40 may comprise any number of light elements. These may include, for example, light emitting diodes (LEDs), incandescent bulbs, compact fluorescent lamps (CFLs), fluorescent bulbs, halogen bulbs, high pressure sodium (HPS) bulbs, hydrogen bulbs, ceramic metal halide (CMH) bulb, and/or any other suitable bulb or light element. For a particular light source, all of the light elements 48 thereof may be the same (i.e., the same type), while in other embodiments a single light source may include light elements that differ from one or more other light elements of the same light source in one aspect or another (e.g., different types of light elements, the same type of light elements that differ in maximum emitted light energy or intensity, etc.).

The light emitted by at least some of the light elements 48 in a given light source 40 may be in the visible portion of the electromagnetic spectrum or may be outside of the visible spectrum. Different light elements 48 may also have different peak intensities in their respective emission spectrums (e.g., one or more light elements may have a peak intensity of 650 nm, while one or more other light elements may have a peak intensity of 500 nm). And as will be described in greater detail below, controlling the intensities of different light elements 48 allows for the adjustment of the overall light spectrum of the light source 40.

The lighting system 36 may include any number of sensors 42 that may be used to sense or detect one or more conditions. The particular sensors 42 included in the system may be dependent upon the particular conditions of interest that are to be sensed or detected. These conditions may include, for example and without limitation: the ambient temperature meeting (or, in an embodiment, meeting or exceeding) a particular threshold; the humidity meeting (or, in an embodiment, meeting or exceeding) a particular threshold; the ambient light meeting (or, in an embodiment, meeting or exceeding) a particular threshold; the temperature of water used for watering the plants meeting (or, in an embodiment, meeting or exceeding) a particular threshold; the wind proximate the planter module 28 meeting (or, in an embodiment, meeting or exceeding) a particular threshold; the time of day, the day of the week, or time of year being a particular time of day, day of the week, or time of year; the planter module 28 being at a particular location; an object being present or within a predetermined distance of the planter module 28; and/or other conditions. Accordingly, the sensors 42 may include, for example, one or a combination of: a temperature sensor for detecting or sensing the ambient temperature proximate the planter module 28; a humidity sensor for detecting or sensing the humidity proximate the planter module; a light sensor for detecting the intensity of light (e.g., ambient light) to which the plant(s) in the planter module 28 is/are being exposed; a water temperature sensor for detecting or sensing the temperature of water used to water the plant(s); a wind speed sensor for detecting or sensing the speed of wind proximate the planter module 28; a precipitation sensor for detecting or sensing the amount of precipitation; a geographic location sensor (e.g., GPS unit) for detecting or sensing the geographic location of the planter module 28; a proximity sensor for detecting or sensing that an object (e.g., a person or an animal) is present or within a predetermined distance of the planter module 28 (e.g., ultrasound proximity sensor, infrared proximity sensor, RFID sensing means, NFC sensing means, facial recognition sensing means, machine vision systems, door switch sensor, break-beam sensor, motion sensor, etc.); and/or any other suitable sensor or sensing means that may be used to sense or detect a particular condition.

In an embodiment, the sensors 42 are electrically connected or coupled to the ECU 38, and the processing device 44 thereof, in particular. The processing device 44 is configured to receive one or more electrical signals from each of one or more of the sensors 42, and that or those signals are used by the processing device 44 to determine whether or not one or more conditions of interest have occurred or exist. For example, if one condition comprises the ambient light reaching a particular threshold intensity, then the processing device 44 may evaluate one or more signals received from a light sensor to determine whether that condition exists. The sensors 42 may be electrically connected or coupled to the ECU 38 via one or more wired or wireless connections. In an instance where a connection between one of the sensors 42 and the ECU 38 is a wireless one, the sensor 42 may include or be electrically connected or coupled to communication-supporting infrastructure (e.g., one or more known components/devices, such as, for example, modems, routers, antennas, electromechanical ports, transceivers, etc.) to allow for the communication and exchange of data between the sensor 42 and the ECU 38.

In some embodiments, the lighting system 36 may include a user interface 50 through which a user may communicate with the ECU 38. In one such embodiment, the user interface 50 may comprise one or a combination of any number of known devices, such as, for example: a liquid crystal display (LCD); a touch screen; a plasma display; a keypad; a keyboard; a computer mouse or roller ball; a microphone; a speaker; a handheld device (e.g., telephone, smartphone, tablet, personal digital assistant (PDA), etc.); one or more switches or buttons; or any other display or monitor device electrically connected or coupled to and configured for communication with the ECU 38 (e.g., through one or more wired or wireless connections).

In another embodiment, the user interface 50 may comprise a user interface of a user input device, such as, for example, the user input device 12 described in detail above, and in such an embodiment, the ECU 38 of the lighting system 36 may be integrated in the user input device. For example, in an instance where the lighting system 36 is part of the system 10 described above, the processing device 44 of the ECU 38 may comprise the processing device 18 of the user input device 12; and the memory device 46 of the ECU 38 may comprise the memory device 20 of the user input device 12.

In still other embodiments, both the user input device 12 and the separate user interface 50 may be provided. In such an embodiment, a user may be able to communicate with the ECU 38 of the lighting system 36 locally through the user interface 50, or locally or remotely via the user input device 12 over, for example, one or more communication networks (e.g., communication network 16) using any number of well-known communication techniques and protocols, such as, for example, one or more of those described elsewhere herein.

In an instance where the lighting system 36 is part of the system 10 and the system 10 also includes the central server 14 described above, the central server 14 may be configured and used to control, perform, govern, or otherwise manage certain operations or functions of the lighting system 36, and the ECU 38 thereof, in particular. To that end, certain data, for example, one or more of software (e.g., code or logic), firmware, programs, applications, information, algorithms, scripts, data structures, etc., required to perform functions the ECU 38 and lighting system 36 as a whole, may be stored in the memory device 26 of the central server 14. The central server 14 may be electrically connected or coupled to and configured for communication with the ECU 38. As with the communication discussed above, this communication may be over one or more communication networks (e.g., communication network 16) using any number of well-known communication techniques and protocols, such as, for example, one or more of those described elsewhere herein.

Whether the lighting system 36 is a standalone system or a component of a larger system (e.g., system 10), the lighting system 36 may be operated in a number of different modes. And in an embodiment where the system 36 is operable in different modes, one or more operating parameters of one or more of the light elements 48 of the light source 40 may be different from one mode to another, or even within a given mode when certain predetermined conditions are met.

For example, in an embodiment, the lighting system 36 may be operated in a growth mode and an illumination mode. In the growth mode, the light source 40 is operated in a manner to stimulate or promote plant growth. In the illumination mode, the light source 40 is operated in a manner to illuminate the plants so that, for example, the plant(s) can be visually inspected and/or tended to. It will be appreciated that while only two modes have been identified above, the present disclosure is not intended to be limited to any particular number or type(s) of modes.

In an embodiment where the lighting system 36 is a multi-modal system, the mode in which the light source 40 is operated may be selected in a number of ways. One way is in response to a user selection made through, for example, with the user interface 50 of the lighting system 36. Another way is by the system 36 detecting that one or more predetermined conditions have been met, and then automatically selecting the operating mode in which to operate the light source 40 based on that detection. This may comprise evaluating one or more electrical signals received from one or more of the sensors 42 and determining, based on that or those signals, that a particular condition has been met. For example, in one embodiment, a condition for operating the light source 40 in the illumination mode is that a person or animal is in the vicinity of the planter module 28. If a signal is received from a proximity sensor (e.g., a door switch sensor, a break-beam sensor, etc.) that is indicative of a person or animal being present, then the ECU 38 of the lighting system 36 may select the illumination mode (as opposed to the grow mode), and then may control the light element(s) 48 of the light source 40 accordingly.

How a particular light element 48 of the light source 40 is operated in a particular mode is dependent upon the mode itself. For example, in one mode, a light element may be operated at full brightness and intensity, while in another mode, that same light element may not be operated at all (i.e., OFF), or at a brightness or intensity level that is below the maximum. In any event, the light elements 48 are controlled in such a way that one or more desired operating parameters or characteristics of the light source 40 for a selected mode is/are achieved.

In an embodiment, the operating parameter(s) of each light element 48 for each mode of operation are stored in a data structure that, in turn, is stored in a memory device, for example, the memory device 46 of the ECU 38. In an embodiment where the lighting system 36 is a component of a larger system, the data structure may alternatively be stored in memory device of that system. For example, in an embodiment where the lighting system 36 is part of system 10, the operating parameters may be stored in a data structure stored in or on a memory device of or accessible by the user input device 12 and/or the central server 14. In any event, for each operating mode, predetermined operating parameters of the light elements 48 are empirically derived and stored in a data structure that correlates lighting system operating modes with light element operating parameters. Then, when a particular mode is selected, the processing device 44 of the ECU 38, for example, may access the data structure and, using the selected mode, determine (e.g., look-up) the light element operating parameters corresponding to the selected mode. The processing device 44 may then control, or cause to be controlled, the operation of the light elements 48 in accordance with the predefined operating parameters acquired from the data structure (e.g., the amount of current supplied to one or more light elements may be controlled, one or more light elements may be rapidly turned ON and OFF using pulse width modulation technique, etc. to achieve a particular operating parameter).

It will be appreciated that while use of a data structure to determine the operating parameters of light elements has been described above, in other embodiments the operating parameters may be determined using, for example, one or more suitable equations or algorithms. Accordingly, the present disclosure is not intended to be limited to any particular means or techniques for determining light element operating parameters for a selected mode of operation.

As briefly described above, the operating parameters of individual light elements 48 may be set or determined so as to achieve certain operating parameter(s) or characteristic(s) of the light source 40 as a whole. This may include, for example, achieving a particular overall brightness, intensity, and/or spectrum of the light source 40. For example, to achieve a relatively high overall output intensity of the light source 40, all of the light elements 48 may be activated or turned on, and the output intensities of each may be controlled to achieve the desired overall output intensity. And to achieve a relatively low overall output intensity, some of the light elements 48 may be deactivated or turned off, and the output intensities of one or other light elements 48 may be controlled to achieve the desired intensity.

In another example, at least some light elements 48 of the light source 40 may be controlled in order to achieve a particular spectrum of the light source 40. For example, assume that one or more light elements 48 comprise 650 nm light elements, and another one or more light elements 48 comprise 500 nm light elements. To achieve a particular spectrum of the light source 40 using the existing light elements, the 650 nm light elements may be controlled to 40% of their maximum intensity, and the 500 nm light elements may be controlled to 30% of their maximum intensity. These light elements could then be controlled to be 80% and 60% intensity, respectively, so that the desired spectrum and/or intensity is achieved.

Accordingly, it will be appreciated in view of the forgoing that the light elements 48 of the light source 40 may be controlled together, individually, or in groups (less than all) so as to achieve a desired overall operating parameter of the light source 40.

In addition to controlling one or more operating parameters of light elements 48 of the light source 40 in accordance with a selected operating mode, in some embodiments, one or more operating parameters of the light elements 48 may be controlled within a given mode if and when certain conditions are met. These conditions may include, but are certainly not limited to, those relating to the environment surrounding the planter module 28 (e.g., the ambient temperature, humidity, light, etc. meeting (or exceeding) a predetermined threshold).

In such an embodiment, when it is detected by, for example, the ECU 38 that a particular condition has been met, the processing device 44 of the ECU 38 may access a data structure that correlates certain predetermined conditions with empirically derived operating parameters for the light elements 48 of the light source 40 to determine (look-up) the light element operating parameters corresponding to the detected condition. The processing device 44 may then control, or cause to be controlled, the operation of one or more of the lighting elements 48 in accordance with the predefined operating parameters acquired from the data structure (e.g., the amount of current supplied to one or more light elements may be controlled, one or more light elements may be rapidly turned ON and OFF using pulse width modulation technique, etc. to achieve a particular operating parameter). Again, it will be appreciated that while use of a data structure to determine the operating parameters of light elements has been described above, in other embodiments the operating parameters may be determined using, for example, one or more suitable equations or algorithms. Accordingly, the present disclosure is not intended to be limited to any particular way(s) of doing so.

### Plant Imaging

Another feature of the present disclosure relates to imaging one or more plants for purposes of obtaining information about the plant(s) being imaged. This information may include, for example, plant species (based on plant size, leaf shape, color, etc.), plant size (for tracking growth and/or determining developmental stage of the plant), plant health (based on discoloration, the presence of one or more of spots, dead portions, mold, etc.), the presence of insects or other pests, plant shape, plant respiration, plant photosynthesis rate, and the like.

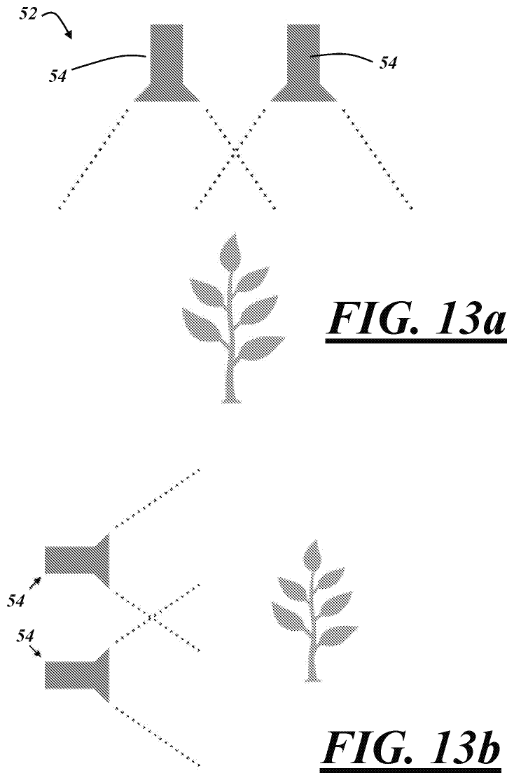

In an embodiment such as that illustrated in FIGS. 13a and 13b, a plant imaging system 52 may comprise one or more imaging devices (e.g., cameras) 54 configured to obtain images of one or more plants, and an ECU (not shown) configured to receive images obtained by the imaging device (s) 54 and to process the image(s) to obtain information about the plant(s) being imaged. In an embodiment, the imaging system 54 may be part of a larger system, for example, system 10 and/or lighting system 36 described above, while in other embodiments, the imaging system 52 may be a standalone system that is not part of a larger system.

In an embodiment, multiple imaging devices 54 are used in order to obtain three-dimensional information about the plant(s) being imaged. One or more of these imaging devices may be stationary or fixed, or all of the imaging devices 54 may be moveable. In other embodiments, a single imaging device 54 may be used to obtain three-dimensional information by, for example, moving the imaging device 54 relative to the plant in order to obtain three-dimensional information. That is, a single imaging could take photos from many points relative to the plant and the individual images could be combined together using known image processing techniques to create a three-dimensional reconstruction of the plant. Information related to the plant may then be obtained from the three-dimensional reconstruction.

FIGS. 13a and 13b depict embodiments of the imaging system 52 wherein a pair of imaging devices 54 are configured to obtain images from above a plant (FIG. 13a) and from the side of the plant (FIG. 13b). The imaging devices 54 may also be used to obtain images of the plant from any other angle or point relative to the plant that is within the operating constraints of the imaging devices and/or one or more actuators configured to move the imaging devices 54 (if applicable).

As briefly alluded to above, the imaging devices 54 may be fixed relative to the plant, or one or more imaging devices 54 may be moveable either manually or automatically through the use of one or more actuators (e.g., linear actuators). Further the imaging devices 54 may be mounted or carried by the planter module 28 in which the plant(s) being imaged are planted, may be mounted or carried by a lighting system (e.g., the light source 40 described above), or may be standalone devices that are separate and distinct from any other devices or systems.

Using images acquired by the imaging devices 54, the ECU, which may have the same or similar construction as other ECUs described elsewhere above, may be configured to obtain information relating to the imaged plant. For example, using the known height of the imaging device(s) 54 and the known spacing between the imaging device(s) and the plant, dimensions of the plant (e.g., height, width, diameter) may be determined. Other information about an imaged plant may be obtained by comparing one or more images of the plant with one or more other images stored in a data structure that, in turn, is stored in or on a memory device of or accessible by the ECU of the system 52. And when there is a match between an acquired image and a stored image, information associated with the stored image can be ascribed to the acquired image, and thus, the plant corresponding thereto.

In an embodiment where the imaging system 52 is part of a larger system, for example, the system 10 and/or the lighting system 36 described above, the ECU of the imaging system 52 may be embodied in a component of that larger system. For example, in an instance wherein the imaging system is part of the lighting system 36, the ECU 38 of the imaging system 36 may also comprise the ECU of the imaging system 52. Similarly, in an instance where the imaging system is part of the system 10, the processing device 18 and memory device 20 of the user input device 12 may comprise the ECU of the imaging system, or the processing device 24 and memory device 26 of the central server may comprise the ECU of the imaging system.

In any event, the information obtained about an imaged plant may be communicated to a user of the imaging system 52 via, for example, a user interface of the system 52 (e.g., a display screen). In one embodiment, the user interface may comprise one or a combination of any number of known devices, such as, for example: a liquid crystal display (LCD); a touch screen; a plasma display; a keypad; a keyboard; a computer mouse or roller ball; a microphone; a speaker; a handheld device (e.g., telephone, smartphone, tablet, personal digital assistant (PDA), etc.); or any other display or monitor device electrically connected or coupled to and configured for communication with the ECU of the system 52 (e.g., through one or more wired or wireless connections). In another embodiment, the user interface may comprise a user interface of a different component of the system 52 or a component of a larger system of which the imaging system is a part (e.g., the user input device 12 of the system 10, the user interface 50 of the lighting system 36, etc.). Accordingly, one of ordinary skill in the art will appreciate that any number of user interfaces may be used to communicate information to a user, and thus, the present disclosure is not intended to be limited to any particular type of interface.

### Robotic System for Plant Growth and Harvesting

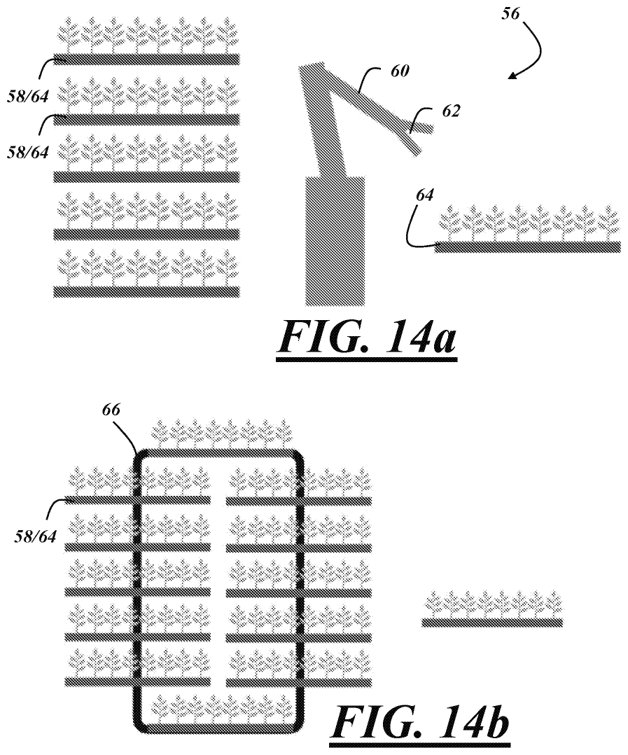

Yet another feature of the present disclosure relates to a robotic plant storage and retrieval system 56. An embodiment of such a system is illustrated in FIG. 14a. In the illustrative embodiment, the system 56 comprises a plurality of racks 58 on which plants may be stored, a robotic arm 60 having an end effector 62 configured to grip a planter or a shelf 64 on which a plant/planter is disposed, and a controller or ECU (not shown) configured to control movement of the robotic arm 60 and operation of the end effector 62 thereof.

The racks 58 may be organized and arranged in a number of ways. As shown in FIG. 14a, the racks 58 may be arranged vertically at fixed locations, while in other embodiments, the racks may be arranged and fixed horizontally or at one or more angles. In yet other embodiments, the racks 58 may be movable by, for example, a conveyor, carousel, or robot. FIG. 14b depicts one such embodiment wherein the racks 58 are rotated by a motor driven belt or chain 66. In any event, the racks 58 may be configured to hold a single plant and/or a tray 64 on which multiple plants may be stored.

In operation, the controller or ECU of the system 56, which may have the same or similar construction as other ECUs described herein, is configured to determine that a plant or tray is to be retrieved and to control the robotic arm 60 and end effector 62 thereof to do so. The controller may be configured to make this determination in a number of ways, for example, automatically based on a predetermined schedule, in response to the receipt of an instruction from a user made through, for example, a user interface or user input device, or any other suitable way. Once the determination is made as to what plant or tray of plants is to be retrieved, the robotic arm 60 and the end effector 62 thereof may be controlled to move to the known location of the plant or tray, to grip the plant or tray, and to move the plant or tray to a predetermined designated location at which, for example, the plant or plants may be tended to (e.g., watered, fed, pruned, observed, harvested, etc.). In some embodiments, the robotic arm 60 is configured to retrieve one plant or tray at a time, while in other embodiments, multiple plants or trays may be retrieved at the same time.

In an embodiment where the racks 58 are at fixed locations (i.e., the racks do not move) the location of each plant or tray plants may be programmed into a memory device of the controller such that the controller knows where each plant/tray is located and how the robotic arm has to be controlled to retrieve it. Alternatively, in an embodiment wherein the racks may move, the location of each plant/tray may be periodically communicated to the controller so that the location of each plant/tray can be tracked by the controller. In such an embodiment, one or more encoders or sensors may be used to track the location of plants/trays using known techniques.

It will be appreciated in view of the above that the system 56 may take a number of forms and/or operate in a number of ways, and as such, the present disclosure is not intended to be limited to any particular form(s) or way(s).

### Autonomously Moveable Planter

Still another feature of the present disclosure relates to an autonomously moveable planter. In general terms, the moveable planter is configured to autonomously move based on certain predetermined criteria or logic. For example, in an embodiment, the moveable planter is configured to move around a defined area based on lighting conditions within that area. More particularly, the moveable planter may move around until desired lighting conditions are found using one or more sensors carried by the planter (e.g., a camera or a light sensor). Additionally, or alternatively, while stationary, a suitable sensor may be used to find a location having desired lighting conditions, and then the moveable planter may be moved to or near that location. In certain embodiments, the planter may also be configured to return to a “home” location based on certain conditions being met, for example, it being a certain time of day, a person being present within or within a predetermined distance of the defined area in which the planter may move, etc.

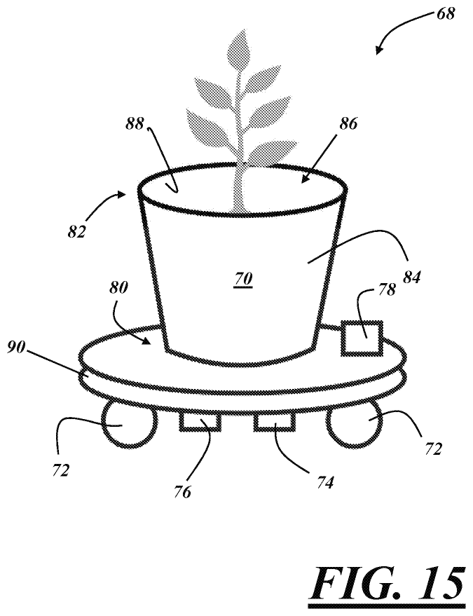

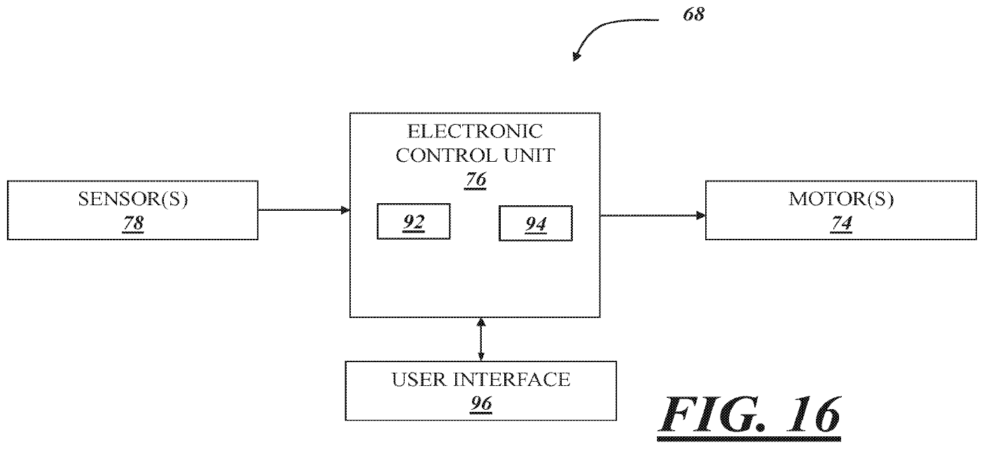

FIGS. 15 and 16 depict an illustrative embodiment of a moveable planter 68. In this embodiment, the planter 68 comprises a container 70 in which one or more plants may be planted, one or more wheels 72, one or more electric motors 74 each configured to drive at least one of the one or more wheels 72, an ECU 76 configured, at least in part, to control or govern the operation of the motor(s) 74, and one or more sensors 78 that may be used to, for example, sense or detect lighting conditions in a given field of view of the sensor(s) 78, among possibly other components.

The container 70 may comprise any number of known containers in which plants may be planted, and may be composed of, for example, plastic, ceramic, glass, or any other suitable material. The container 70 may include a closed end 80, an open end 82, and a body 84 extending therebetween along a longitudinal axis A. The container 70 further includes a container interior 86 defined, at least in part, by an interior surface 88 of the container body 84 facing radially inwardly relative to the axis A.

In an embodiment, the wheel(s) 72 are mounted or affixed to the closed end 80 of the container 70 using, for example, known mounting arrangements and/or fasteners. In other embodiments, however, the wheel(s) 72 may be mounted or affixed to a base 90 that is configured to carry the container 70. In an embodiment where the base 90 carries the container 70, the container may be mounted or affixed to the base, or the base may be integrally formed with the container. In any event, the wheel(s) 72 may comprise any number of suitable wheels known in the art. For example, in some embodiments, the wheel(s) 72 may comprise one or more holonomic wheels that may be independently rotated and precisely controlled. The wheel(s) 72 may be configured and/or arranged such that the planter 68 may rotate in place, rotate while traveling in a linear direction, and/or travel in a linear direction without rotating.

One or more of the wheel(s) 72 may be controlled or driven by the one or more electric motors 74. In some embodiments, all of the wheels 72 may be driven by the same electric motor. In other embodiments, however, a subset (but less than all) of the wheels 72 may be driven by the same electric motor; and in still other embodiments, multiple motors 74 may be provided wherein each motor drives a single wheel or a subset of wheels. In any event, each motor 74 is operatively coupled to the wheel(s) 72 that that particular motor 74 is configured to drive. The motor 74 may be directly coupled to the wheel 72 (e.g., the output shaft of the motor is directly coupled to an axle of the wheel) or may be indirectly coupled through one or more other components (e.g., the output shaft of the motor is coupled to the axle of the wheel through one or more other components (e.g., gears, linkages, etc.)).

The motor(s) 74 may comprise any suitable motor known in the art. In an embodiment, the motor(s) 74 may be carried by the container 70 at the closed end 80 thereof. In other embodiments, the motor(s) 74 may be carried by the base 90 (if applicable), or another suitable component of the planter 68. The motor(s) 74 may be powered by a power source, for example, one or more rechargeable batteries (e.g., one or more lead-acid, nickel cadmium (NiCd), nickel-metal hydride (NiMH), lithium-ion, and/or lithium-ion polymer batteries or battery cells). It will be appreciated, however, that other suitable power sources may certainly be used in addition to or in place of that or those identified above.

The operation of the motor(s) 74 may be controlled, governed, or otherwise managed by the ECU 76 of the planter 68. Accordingly, the ECU 76 is electrically connected or coupled to (e.g., hardwired or wirelessly) and configured to communicate with each of the motor(s) 74. The ECU 76 may comprise a processing device 92 and a memory device 94 that is part of electrically connected or coupled to or accessible by the processing device 92.

The processing device 92 may include any type of suitable electronic processing device (e.g., programmable microprocessor, microcontroller, central processing unit (CPU), application specific integrated circuit (ASIC), etc.) that is configured to process data and/or execute appropriate programming instructions for software, firmware, programs, applications, algorithms, scripts, etc., necessary to perform various functions of the ECU 76 and/or some or all of functionality of the planter 68 and the components thereof described herein below. In some embodiments, the processing device 92 may include or be electrically connected or coupled to certain communication-supporting infrastructure (e.g., one or more known components/devices, such as, for example, modems, routers, antennas, electromechanical ports, transceivers, etc.) to allow for the communication and exchange of data between the ECU 92 and one or more other components or devices of the planter 68 or otherwise.

The memory device 94 may include, for example, random access memory (RAM), read only memory (ROM), hard disk(s), universal serial bus (USB) drive(s), memory card(s), erasable programmable memory (e.g., EPROM and EEPROM); flash memory, or any other type of suitable electronic memory means, and may store a variety of data. This data may include, for example, one or more of software (e.g., code or logic), firmware, programs, applications, information, algorithms, scripts, data structures, etc., required to perform functions of the ECU 76 and/or one or more other components of the planter 68. Alternatively, rather than all of the aforementioned information/data being stored in a single memory device, in an embodiment, multiple suitable memory devices may be provided.

In operation, and as will be described in greater detail below, the ECU 76 is configured to determine what movement of the planter 68 is needed or desired, and to then cause the motor(s) 74 to drive one or more of the wheel(s) 72 to execute that movement. This may comprise driving all of the wheels(s) 72 or driving a subset but not all of the wheels 72.

The sensor(s) may be used to detect or sense parameters or conditions relating to the criteria on which movement of the planter 68 is based. For example, in an embodiment wherein the planter 68 is configured to move to an area having desired lighting conditions (e.g., bright or brighter light), the sensor(s) 78 may comprise one or more light sensors (e.g., photodiode, photoresistor, ambient light sensor, or any other photodetector) or imaging devices (e.g., cameras) configured for use in detecting, sensing, or measuring one or more attributes of light within a field of view of the sensor(s) 78.

In certain embodiments, the sensor(s) 78 may also include one or more sensors for detecting the presence of obstacles in the path of the planter 68 for purposes of avoiding collisions between the planter 68 and an obstacle in its path. This may include, for example, one or more proximity sensors, cameras, ultrasonic range finder sensors, or other suitable sensing means for detecting objects. In certain embodiments, the object detecting sensor(s) may comprise the same sensor(s) that are used for detecting or sensing parameters or conditions relating to the criteria on which movement (e.g., one or more cameras that serve the dual purpose of object detection and light sensing).

In any event, the sensor(s) 78 may be carried by a component of the planter 68. For example, one or more of the sensor(s) 78 may be mounted on or affixed to the container 70. If applicable, one or more of the sensor(s) 78 may be mounted on or affixed to the base 90 of the planter 68. Accordingly, it will be appreciated that the present disclosure is not intended to be limited to any particular placement of the sensor(s) 78, but rather any suitable placement may be used. Additionally, the sensor(s) 78 may fixed in place or stationary, or one or more of the sensor(s) 78 may be configured for movement (e.g., rotation) about or along a given axis. In an embodiment where the sensor(s) 78 are fixed or stationary, different sensors 78 may have different orientations so as to be able to detect/sense parameters/conditions in different directions. In an embodiment wherein one or more sensor(s) 78 is/are configured for movement, each of those sensor(s) 78 may be coupled to an actuator (not shown) that is configured to move the sensor(s) 78. In such an embodiment, the ECU 76 may be configured to control or govern the operation of the actuator(s).

The sensor(s) 78 may be electrically connected or coupled to and configured for communication with the ECU 76, and the ECU 76 may be configured to use electrical signals received from the sensors 78 to carry out certain functionality of the planter 68. The connection(s) between the ECU 76 and the sensor(s) 78 may be a hardwired connection or a wireless connection. In an embodiment where one or more of the sensors 78 is wirelessly connected to the ECU 76, communication between that sensor 78 and the ECU 76 may be carried out over a communication network using any number of well-known communication techniques and protocols, such as, for example, one or more of those described elsewhere herein.

As briefly described above, in an embodiment, the ECU 76 is configured to determine what movement of the planter 68 is needed or desired. The ECU 76 may use electrical signals received from one or more sensor(s) 78 to do so. For example, the ECU 76 may use electrical signals received from sensor(s) 78 configured for use in detecting or sensing lighting conditions to determine a location having particular or desired lighting conditions, and to then determine what movement is necessary to move the planter 68 to or at least in the direction of that location.

More particularly, the received signals may be used to evaluate and/or determine the lighting conditions in multiple directions from the planter 68 in order to identify a location having the most desirable (e.g., brightest or brighter) lighting conditions. One of ordinary skill in the art will appreciate that any number of known techniques may be used to evaluate and/or determine lighting conditions from electrical signals received from sensors configured for use in detecting or sensing lighting conditions. For purposes of illustration, however, one way is that an imaging device is configured to obtain one or more images of different areas/locations surrounding the planter 68. The ECU 76 is then configured to use that or those images (e.g., by comparing them with one another) to determine which location has the most desirable lighting conditions (e.g., the brightest are), and thus, which location the planter should be moved to. Another way is that one or more photodiodes, photoresistors, and/or ambient light sensors is/are configured to detect light in different directions. The ECU 76 is then configured to determine from readings obtained from that or those devices the direction from which the brightest light was detected, and thus, in which direction the planter 68 should be moved. Accordingly, any number of ways may be used to evaluate and/or determine lighting conditions, and thus, the present disclosure is not intended to be limited to any particular way(s) of doing so.

In addition to the above, the ECU 76 may also use electrical signals received from sensor(s) 78 configured for use in detecting the presence of an object in the path of the planter 68 and techniques well-known in the art, to determine what movement, if any, is necessary to avoid the detected object. The ECU 76 may then control the motors 74 to avoid the detected object, if needed.

In addition to the components described above, in some embodiments, the planter 68 may also include a user input device or user interface 96 through which a user may communicate with the planter 68, and the ECU 76 thereof, in particular, for a variety of purposes, some of which will be described below. In one such embodiment, the user interface 96 may comprise one or a combination of any number of known devices, such as, for example: a liquid crystal display (LCD); a touch screen; a plasma display; a keypad; a keyboard; a computer mouse or roller ball; one or more switches or buttons; a microphone; a speaker; a handheld device (e.g., telephone, smartphone, tablet, personal digital assistant (PDA), etc.); or any other display or monitor device, electrically connected or coupled to and configured for communication with the ECU 76 (e.g., through one or more wired or wireless connections). In an embodiment where the user interface 96 is configured to communicate wirelessly with the ECU 76, that communication may be carried out over a communication network using any number of well-known communication techniques and protocols, such as, for example, one or more of those described elsewhere herein.

One reason that a user may want to communicate with the planter is that in certain embodiments, the planter may be configured to allow a user to program when the planter may be permitted to move (e.g., on which days of the week and/or between which times of the day (e.g., 7:00 am-5:00 pm)). In such an embodiment, a user may interact with the user interface 96 to select or input the desired information. That information may then be received by the ECU 76 and stored in, for example, the memory device 94 thereof. Another reason is that in some embodiments, the planter 68 may be configured to allow a user to program a “home” location to which the planter 68 is to return when certain conditions are met. In such an embodiment, a user may interface with the user interface 96 to set the “home” location. The ECU 76 may then receive the indication and record the location (e.g., the GPS coordinates) in, for example, the memory device 94. Accordingly, it will be appreciated that a variety of information may be provided to the ECU 76 of the planter for any number of reasons, and thus, the present disclosure is not intended to be limited to any particular information or reason(s).

For purposes of illustration only, one example of the operation of the planter 68 will now be provided. In this example, upon activation of the moveable planter 68 located at predetermined “home” location, the ECU 76 receives one or more electrical signals from one or more of the sensor(s) 78 that may be used to determine or detect the lighting conditions in multiple directions from the “home” location so that a location or direction having the most desirable (e.g., brightest or brighter) lighting conditions can be identified.

The ECU 76 may receive electrical signals from one sensor 78 or from multiple sensors. In an instance where the signals are received from a single sensor, each signal may be representative of lighting conditions in a single direction or, if the sensor has a sufficiently large field of view, may representative of lighting conditions in multiple directions. Similarly, in an instance where the signals are received from multiple sensors, the signals received from each sensor may be representative of lighting conditions in a single direction or, if the sensor has a sufficiently large field of view, may representative of lighting conditions in multiple directions. In any event, the ECU 76 is configured to process the received signals and to determine a location or direction having the most desirable lighting conditions, which may be the location/direction corresponding to the brightest light detected or may simply be a location/direction having brighter light than the current location of the planter 68.

Once a location or direction is identified, the ECU 76 is configured to determine one or more directions in which to move the planter 68 so that the plant(s) therein will be exposed to the more desirable lighting conditions. The known positioning and/or orientation of the sensor(s) 78 from which signals were received may be used to determine the appropriate direction in which to move the planter 68 (e.g., the orientation of the sensor from which the signal determined to represent or correspond to the most desirable lighting conditions was received may be used as the direction in which the planter should move.

The ECU 76 is then configured to command one or more of the motor(s) 74 to drive one or more of the wheel(s) 72 in a particular way to move the planter 68 in the appropriate direction. As the planter 68 moves, the ECU 76 may be configured to continuously or periodically receive electrical signals from one or more sensor(s) 78 to monitor the lighting conditions within the field of view of the sensor(s) 78, and/or to avoid collisions with objects in the path of the planter 68. Further, if and when the planter 68 stops at a particular location, the ECU 76 may be configured to continuously or periodically (e.g., once every predetermined number of minutes) reevaluate the lighting conditions in the same manner described above to determine whether a different location or direction has more desirable conditions, and if so, to move the planter 68 to that location or in that direction. In an embodiment, the ECU 76 is also configured to determine an orientation of the planter once the planter arrives at a given location, and to command one or more of the motor(s) 74 to drive one or more of the wheel(s) 72 in a particular way to cause the planter to assume the determined orientation.

As briefly described above, in certain embodiments, the planter 68 may configured to move to a predefined “home” location if and when certain conditions are met, for example, at a certain time of day and/or when the presence or proximity of a person is detected. In such an instance, the ECU 76 may be configured to control the planter 68 move to that location when it determines that the relevant condition(s) is/are met. This may be carried out or performed in a number of ways.

One way may be that the planter 68 is GPS-enabled (e.g., includes a GPS unit), and the GPS coordinates of the “home” location are programmed into the ECU 76 (i.e., the memory 94 thereof). The coordinates may be programmed as part of an initial set-up routine and/or in response to user input to do so. In any event, in such an embodiment, the ECU 76 would be configured to cause the planter 68 to return to those programmed coordinates when the relevant condition(s) is/are met.

Another way may be that a beacon (e.g., a solid light or flashing light) may be placed at the “home” location, and may be activated (e.g., illuminated) wirelessly by the ECU 76 or another component when it is determined that the planter 68 is to return to the “home” location. In such an embodiment, one or more sensor(s) 78 of the planter 68 may be configured to detect the activation of the beacon, and to provide a signal indicative of the same to the ECU 76. The ECU 76 would then control the motor(s) 74 of the planter 68 to cause the planter to return to the “home” location. One way the sensor(s) 78 may be configured to detect the activation of the beacon, though certainly not the only way, would be for the beacon to comprise a flashing light and for the sensor 78 to detect flashing at a known frequency. The ECU 76 may then control the motor(s) to move the planter in the direction which the flashing is the brightest. The light emitted by the beacon may be either visible or nonvisible light, depending on the implementation.

In any event, it will be appreciated that the return of the planter 68 to a “home” location may be carried out in any number of ways, and thus, the present disclosure is not intended to be limited to any particular way(s) of doing so.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An automated system for planning the placement of plants in a planter module having a plurality of cells in which plants may be placed, comprising:
an electronic processor having one or more electrical inputs and one or more electrical outputs;
an electronic memory device electrically coupled to the electronic processor and having instructions stored therein;
wherein the electronic processor is configured to access the memory device and execute the instructions stored therein such that the electronic processor is configured to:
receive one or more electrical signals representative of information relating to plants to be planted in the planter module;
acquire information relating to the plurality of cells of the planter module;
determine an exclusion zone for each plant to be planted in the planter module based on at least one of the received information relating to the plants and the acquired information relating to the planter module cells; and
create a planting arrangement for the plants to be planted in the planter module based on the determined exclusion zones, wherein each plant is assigned one or more cells of the planter module in which it is to be placed.

2. The system of claim 1, wherein the processor is further configured to cause an indication of the cell assignments to be provided to a user.

3. The system of claim 1, wherein the received information comprises one or a combination of:
one or more types of plants to be planted in the planter module;
a number of each type of plant to be planted in the planter module;
a size of one or more plants to be planted in the planter module;
a stage of plant growth for one or more of the plants to be planted in the planter modules;
a shape of one or more plants to be planted in the planter module; and
a type of lighting to be used to promote growth.

4. The system of claim 1, wherein the acquired information relating to the plurality of cells comprises one or a combination of:
a size of one or more of the cells;
a shape of one or more of the cells;
a number of cells;
spacing between cells; and
a location of each of the cells.

5. The system of claim 1, wherein the processor is configured to create the planting arrangement such that none of the exclusion zones of the plants overlap.

6. The system of claim 1, wherein the processor is configured to create the planting arrangement such that there is an allowable amount of overlap between exclusion zones of certain plants.

7. The system of claim 1, wherein the processor is configured to determine the exclusion zone for each plant by looking up the received information corresponding to that plant in a data structure and identifying the exclusion zone correlated with that information in the data structure.

8. The system of claim 1, wherein the system comprises a user input device, a central server, and a communication network to facilitate communication between the user input device and the central server, and further wherein the central server comprises the electronic processor and the electronic memory device, and the information relating to the plants received by the electronic processing device is received from the user input device.

9. The system of claim 8, wherein the user input device comprises a user interface configured to allow a user to input the received information relating to the plants.

10. The system of claim 1, wherein the processor is configured to receive one or more electrical signals representative of one or more user-defined constraints relating to plant placement, and the processor is further configured to create the planting arrangement based additionally on the one or more user-defined constraints.

11. A method of planning the placement of plants in a planter module having a plurality of cells in which plants may be placed, comprising:
receiving one or more electrical signals representative of information relating to plants to be planted in the planter module;
acquiring information relating to the plurality of cells of the planter module;
determining an exclusion zone for each plant to be planted in the planter module, wherein the determination for each plant is based on at least one of the received information relating to the plants and the acquired information relating to the planter module cells; and
automatically creating a planting arrangement for the plants to be planted in the planter module based on the determined exclusion zones, wherein each plant is assigned one or more cells of the planter module in which it is to be placed.

12. The method of claim 11, further comprising causing an indication of the cell assignments to be provided to a user.

13. The method of claim 11, wherein the received information comprises one or a combination of:
one or more types of plants to be planted in the planter module;
a number of each type of plant to be planted in the planter module;
a size of one or more plants to be planted in the planter module;
a stage of plant growth for one or more of the plants to be planted in the planter modules;
a shape of one or more plants to be planted in the planter module, and a type of lighting to be used to promote growth.

14. The method of claim 11, wherein the acquired information relating to the plurality of cells comprises one or a combination of:
a size of one or more of the cells;
a shape of one or more of the cells;
a number of cells;
spacing between cells; and
a location of each of the cells.

15. The method of claim 11, wherein the creating step comprises creating the planting arrangement such that none of the exclusion zones of the plants overlap.

16. The method of claim 11, wherein the creating step comprises creating the planting arrangement such that there is an allowable amount of overlap between exclusion zones of certain plants.

17. The method of claim 11, wherein the determining step comprises looking up the received information corresponding to a given plant in a data structure and identifying the exclusion zone correlated with that information in the data structure.

18. The method of claim 11, further comprising receiving one or more electrical signals representative of one or more user-defined constraints relating to plant placement, and wherein the creating step comprises creating the planting arrangement based additionally on the one or more user-defined constraints.

19. A non-transitory, computer-readable storage medium storing program instructions that when executed by one or more electronic processors cause the one or more processors to perform the steps of:
receiving one or more electrical signals representative of information relating to plants to be planted in the planter module;
acquiring information relating to the plurality of cells of the planter module;
determining an exclusion zone for each plant to be planted in the planter module, wherein the determination for each plant is based on at least one of the received information relating to the plants and the acquired information relating to the planter module cells; and
automatically creating a planting arrangement for the plants to be planted in the planter module based on the determined exclusion zones, wherein each plant is assigned one or more cells of the planter module in which it is to be placed.

20. The computer-readable storage medium of claim 19, wherein when executed by the one or more electronic processors, the program instructions further cause the one or more electronic processors to perform the step of causing an indication of the cell assignments to be provided to a user.
